(19) United States
(12) Patent Application Publication
(10) Pub. No.: US 2025/0065710 A1
(43) Pub. Date: Feb. 27, 2025

(54) Vehicle Loading or Fuel Filler Flap Module

(71) Applicant: Illinois Tool Works Inc., Glenview, IL (US)

(72) Inventors: Erik DILJE, Würzburg (DE); Constantin MAHLER, Gerolzhofen (DE)

(21) Appl. No.: 18/807,669

(22) Filed: Aug. 16, 2024

(30) Foreign Application Priority Data
Aug. 22, 2023 (DE) 10 2023 122 463.8

(51) Int. Cl. B60K 15/05; B60L 53/16

(52) U.S. Cl. CPC B60K 15/05; B60L 53/16

(57) ABSTRACT

The disclosure relates to a charging or fueling module (1) of a vehicle. The charging or fueling module (1) includes a base body (2) for mounting the charging or fueling module (1) on a body structure of the vehicle, a flap or cover body (3) mounted pivotally or movably on the base body (2), and an aperture body (13) mounted on the flap or cover body (3) via a plurality of fastening elements, which, when the flap or cover body (3) takes on a closed position, extends flush with an outer skin of the body structure of the vehicle. Each fastening element includes a first connection partner (5) fixedly connected to the flap or cover body (3) or to the retaining body of the flap or cover body (3) and a second connection partner (6) fixedly connected to a rear side of the aperture body (13). The first connection partner (5) is arranged at least partially or regionally in a complementary manner to the second connection partner (6) and to form a releasable, positive-locking connection with the second connection partner (6).

### RELATED APPLICATIONS

The present application claims the benefit of German Patent Application No. 10 2023 122 463.8, filed Aug. 22, 2023, titled “Vehicle Loading or Fuel Filler Flap Module,” the contents of which are hereby incorporated by reference.

### BACKGROUND

Vehicles with hybrid or electric drives, such as PHEVs (plug-in hybrid electric vehicles) or BEVs (battery electric vehicles), are equipped with at least one battery that can be charged via an external electrical connector, typically a charging socket. This charging port is housed in a compartment on the vehicle body, which is covered by a charging flap. A mechanism enables the flap to open and close, granting access to the charging port. Similarly, vehicles with combustion engines feature a fuel tank accessible via a filler neck, also housed in a compartment and covered by a fuel flap, with a similar opening and closing mechanism.

Both the fueling and charging modules typically have a base body mounted on the vehicle structure, with a flap or cover body pivotally attached. An aperture body is mounted on the flap, aligning flush with the vehicle's outer surface when closed. However, mounting this aperture body has traditionally been a labor-intensive, iterative process requiring multiple steps to achieve a proper flush fit. Metal clips, commonly used as fastening elements, complicate the stress-free positioning of the aperture body. Changes in temperature or moisture can alter the properties of these clips, risking misalignment of the aperture body after installation.

Thus, there is a need for a more efficient method of mounting the aperture body on the flap, ensuring it aligns flush with the vehicle's exterior when closed, both in terms of surface and joint quality.

### SUMMARY

The present disclosure relates generally to a charging or fueling module, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1 illustrates schematically and in a top plan view, an exemplary embodiment of the charging or fueling module according to the invention without an aperture body mounted on a flap or cover body of the charging or fueling module, such that the arrangement of the fastening elements for mounting the aperture body on the flap or cover body is discernible.

FIG. 2 illustrates schematically and in respective isometric views, an exemplary embodiment of the two connection partners of a connection element of the charging or fueling module according to FIG. 1, namely in a state in which the aperture body is not (yet) mounted on the flap or cover body.

FIG. 3 illustrates schematically and in respective isometric views, the connection partners of the fastening element shown in FIG. 2, namely in a state in which the aperture body or the (second) connection partner associated with the aperture body forms a releasable, positive-locking connection with the (first) connection partner associated with the flap or cover body.

FIG. 4 illustrates schematically and in respective isometric views, the exemplary embodiment of the connection partners of the connection element according to FIG. 2 when removing the aperture body from the flap or cover body.

FIG. 5A illustrates schematically and in respective isometric views, further views of the connection partners of the connection element according to FIG. 2.

FIG. 5B illustrates schematically and in respective isometric views, further views of the connection partners of the connection element according to FIG. 2.

FIG. 6 illustrates schematically and in respective isometric views, an alternative embodiment of the connection partners for a charging or fueling module according to FIG. 1.

### DETAILED DESCRIPTION

The disclosure relates to a charging or fueling module for a vehicle. In particular, the disclosure relates to an optimized fastening of an aperture body of a charging or fueling module of a vehicle onto a flap or cover body or onto a retaining body of the flap or cover body of a charging or fueling module of a vehicle.

The vehicle in question is primarily one with a hybrid or electric drive, though vehicles with purely combustion-based drives are also within the scope of this disclosure. Hybrid or electric vehicles, such as PHEVs (plug-in hybrid electric vehicles) and BEVs (battery electric vehicles), are equipped with at least one battery or traction battery. These batteries can be charged through an external electrical connector, typically a charging socket, accessible on the vehicle body. Charging occurs by connecting the socket to an electrical charging station or a standard external power source.

The charging connector is typically arranged in a charging housing of the vehicle body, which is covered or closed by a charging flap or a charging closure element. A mechanism that cooperates with the charging flap or charging closure element selectively allows the charging compartment to be opened and closed or the charging flap or charging closure element to be flipped open and closed in relation to the charging compartment, and thus allows access to the charging port.

In vehicles with a combustion-based drive, a fuel tank is supplied with fuel via a tank filler-neck, which is accessible from the outside by connection to a fuel pump or a fuel nozzle, for example. Like the charging port, the filler neck is typically arranged in a filler neck housing that is associated with the vehicle body and is covered or closed by a fuel flap or a tank closure element. Here, too, a mechanism that cooperates with the fueling flap or tank closure element selectively allows the fueling compartment to be opened and closed or the fueling flap or tank closure element to be flipped open and closed in relation to the fueling compartment, and thus allows access to the tank filler-neck.

A fueling module as well as a charging module of the type considered herein, typically comprises a base body through which the fueling module or charging module can be mounted on a body structure of the vehicle. A flap or cover body is movably and pivotably mounted on the base body, wherein an aperture body is mounted on the flap or cover body. Then, when the flap or cover body takes on a closed position, the aperture body extends flush with an outer skin of the body structure of the vehicle.

Mounting the aperture body onto the flap or cover body has traditionally been a labor-intensive, iterative process, requiring multiple steps to achieve a flush alignment with the vehicle's outer skin. Typically, this involves using several fastening elements, often metal clips, to secure the aperture body to the flap or its retaining body. However, these metal clips make it difficult to achieve stress-free positioning, and even, when possible, it requires considerable effort. Additionally, changes in temperature or moisture can affect the properties of these metal clips, leading to misalignment of the aperture body after installation. This results in the aperture body not being flush, or only partially flush, with the vehicle's outer surface.

Accordingly, there is a need for a more efficient method of mounting the aperture body on the flap or its retaining body, ensuring that, when closed, the aperture body aligns perfectly with the vehicle's outer surface, both in terms of surface quality and joint alignment. There is a further need to be able to remove the aperture body from the flap or cover body or from the retaining body of the flap or cover body, even when, for example, due to the failure of an electromotive actuator to actuate the flap or cover body, the flap or cover body is in its closed position.

The present disclosure provides a novel charging module or fueling module of a vehicle. Accordingly, the present disclosure relates to a charging or fueling module of a vehicle, wherein the charging or fueling module comprises a base body for mounting the charging or fueling module on a body structure of the vehicle.

The charging or fueling module further comprises a flap or cover body that can be moved on the base body and is pivotally mounted, as well as an aperture body mounted on the flap or cover body or on a retaining body of the flap or cover body via a plurality of fastening elements. The aperture body mounted on the flap or cover body or on the retaining body of the flap or cover body extends flush with an outer skin of the body structure of the vehicle when the flap or cover body takes on a closed position.

According to the disclosure, it is provided that each fastening element comprises a first connection partner fixedly connected to the flap or cover body or to the retaining body of the flap or cover body and a second connection partner fixedly connected to a rear side of the aperture body. The first connection partner is designed at least partially or regionally in a complementary manner to the second connection partner and is configured to establish a detachable, positive-locking connection with the second connection partner. The connection partners of each fastening element are respectively configured as a plastic part, as an injection-molded plastic part. It can be appreciated that the first connection partner of each fastening element is preferably configured integrally with the flap or cover body or with the retaining body of the flap or cover body, while the second connection partner of each fastening element is preferably configured integrally with the aperture body and with the rear side of the aperture body.

Preferably, the connection partners of each fastening element are configured such that the aperture body can also be removed from the flap or cover body or from the retaining body of the flap or cover body when the flap or cover body takes on the closed position.

This design variant has the advantage that, even if for example an electromotive actuator of the charging or fueling module fails, the aperture body can be removed from the flap or cover body or the retaining body of the flap or cover body when the flap or cover body is in its closed position. This would then be necessary, for example, to provide access to an emergency release.

According to implementations of the charging or fueling module according to the disclosure, it is provided that, in the fastened or mounted state of the aperture body, the connection partners of each fastening element are configured to position the latter in a stressless manner in relation to the flap or cover body or in relation to the retaining body of the flap or cover body.

Thus, it is ensured in an easily implemented yet effective manner that the aperture body extends flush to the desired quality, and preferably also flush in terms of joints, with the outer skin of the body structure of the vehicle, wherein this positioning occurs independently of the temperature and/or a moisture content.

In design variants of the charging or fueling module according to the disclosure, it is provided that the first and/or second connection partner(s) of each fastening element is/are configured to lock together in the desired mounting position of the two connection partners.

Here, for example, it can be appreciated that the first or second connection partner of each fastening element, and preferably the first connection partner, comprises at least one catching projection, which, in the desired mounting position of the two connection partners, is configured to catch into a catching receptacle of the other connection partner, particularly the second connection partner.

In the further developments of the last-mentioned design variants of the charging or fueling module according to the disclosure, it is provided that the connection partners of each fastening element are configured such that a positive-locking connection between the connection partners established in a desired mounting position of the connection partners can only be released after overcoming a predefined or definable force threshold.

Here, the predefined or definable force threshold is defined by at least one tapering reinforcement rib, which is associated with one of the two connection partners, and with the first connection partner.

In particular, the fastening elements are configured such that the aperture body can be mounted on the flap or cover body or on the retaining body of the flap or cover body by a movement, by a superposed movement, of the aperture body in the X/Y direction relative to the flap or cover body or relative to the retaining body of the flap or cover body.

Alternatively or additionally, the fastening elements are configured such that the aperture body can be removed from the flap or cover body or from the retaining body of the flap or cover body by the introduction of a predefined or definable critical force component in the Y direction, preferably by the introduction of a predefined or definable critical force component purely in the Y direction from the flap or cover body or from the retaining body of the flap or cover body.

According to preferred implementations of the charging or fueling module according to the disclosure, it is provided that the first or second connection partner of each fastening element, and preferably the second connection partner, is at least partially or regionally configured as a socket having a receptacle, wherein a plug element of the other connection partner can be inserted into the receptacle in order to establish the positive-locking connection with the other connection partner, in particular with the first connection partner.

In this context, it can be appreciated that the receptacles of the connection partners of each fastening element, being configured at least partially or regionally as a socket are arranged parallel to one another, such that, for mounting the aperture body on the flap or cover body or on the retaining body of the flap or cover body, the aperture body is to be moved in a direction, in particular in a direction parallel to the outer skin of the vehicle, relative to the flap or cover body or to the retaining body of the flap or cover body.

In design variants of the last-mentioned embodiments of the charging or fueling module according to the disclosure, it is provided that the receptacle of the connection partner at least partially or regionally configured as a socket is formed by two guide surfaces arranged opposite one another, wherein the guide surfaces are arranged spaced apart from one another such that an interstice for the plug element is formed.

In this context, it is also contemplated that receptacle of the connection partner at least partially or regionally configured as a socket is configured such that, when the plug element is inserted, the receptacle is elastically widened, wherein a tensioning and clamping ultimately occurs in the desired mounting position.

The disclosure further relates to a vehicle having a charging or fueling module of the aforementioned kind according to the disclosure.

The connection partners 5, 6 of each fastening element, shown schematically in the drawings, are configured such that the aperture body 13 of the charging or fueling module 1 can also be removed from the flap or cover body 3 of the charging or fueling module 1 even when the flap or cover body 3 takes on its closed position.

In particular, the connection partners 5, 6 of each fastening element are configured so that, in the fastened state of the aperture body 13, they can position the latter in a stressless manner in relation to the flap or cover body 3.

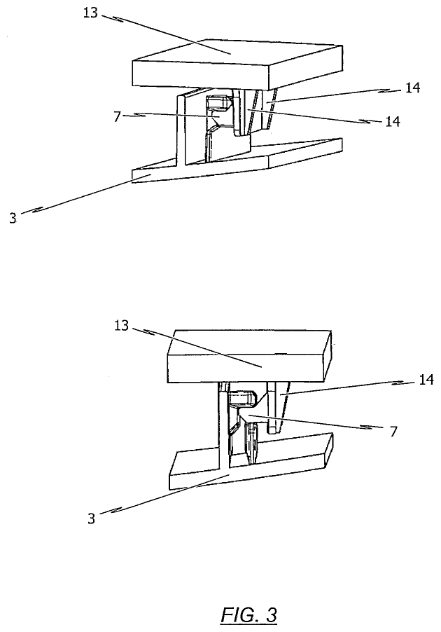

The connection partners 5, 6 are configured to lock together in the desired mounting position of the two connection partners 5, 6 (cf. FIG. 3), wherein a positive-locking connection established between the connection partners 5, 6 in a desired mounting position of the connection partners 5, 6 can be released only after overcoming a predefined or definable force threshold. The force threshold is defined by the tapering reinforcement ribs 14, which are associated with the first connection partner 5.

In particular, in the exemplary embodiment of the charging or fueling module 1 according to the disclosure or of the fastening elements of the charging or fueling module 1 according to the disclosure as shown in the drawings, it is provided that one connection partner 5, 6, and in particular the connection partner 6 associated with the aperture body 13, is at least partially or regionally configured as a socket having a receptacle, into which a plug element of the other connection partner (here: the first connection partner 5, i.e. the connection partner 5 associated with the flap or cover body 3) can be inserted in order to establish a positive-locking connection between the two connection partners 5, 6, and in particular between the socket on the one hand and the plug element on the other hand.

The receptacles of the connection partners 5, 6 of each fastening element, which are respectively configured at least partially or regionally as a socket, are arranged parallel to one another, such that, in particular also for removing the aperture body 13 from the flap or cover body 3, the aperture body 13 is to be moved in a direction, in particular in a direction parallel to the outer skin of the vehicle, relative to the flap or cover body 3.

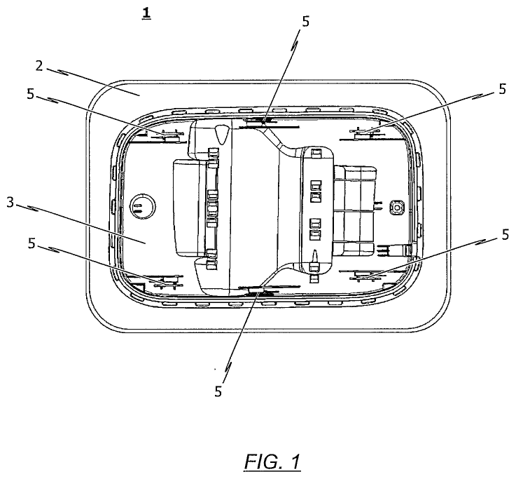

FIG. 1 illustrates schematically and in a top plan view, an exemplary embodiment of the charging or fueling module according to the invention without an aperture body mounted on a flap or cover body of the charging or fueling module, such that the arrangement of the fastening elements for mounting the aperture body on the flap or cover body is discernible. Specifically, in FIG. 1, schematically and in a top plan view, an exemplary embodiment of the charging or fueling module 1 according to the disclosure is shown. To clarify the fastening with which an aperture body 13 (not shown in FIG. 1) is fastened to the flap or cover body 3 of the charging or fueling module 1, the representation of the aperture body 13 is omitted in FIG. 1.

In the exemplary embodiment of the charging or fueling module 1 as shown in FIG. 1, the flap or cover body 3 is pivotally supported in relation to a base body 2 of the charging or fueling module 1. Kinematics (not discernible in FIG. 1) is used for this purpose. In particular, the kinematics is associated with an electromotive drive in order to pivot, as needed, the flap or cover body 3 with the aperture body 13 mounted thereon from a closed position into an open position (and vice versa). However, the disclosure is not limited to pivotally supported flap or cover bodies 3. It is also contemplated that the flap or cover body 3 can be supported at least partially slidably or otherwise movably relative to the base body of the charging or fueling module 1.

It is possible that a plurality of fastening elements is provided on the flap or cover body 3, or alternatively on a retaining body (not shown in FIG. 1) of the flap or cover body 3, to mount an aperture body 13 on the flap or cover body 3 via these fastening elements. This is typically carried out in such a way that, when the flap or cover body 3 takes on a closed position (cf. the position shown in FIG. 1), the aperture body 13 extends in a straking or flush manner with an outer skin of the body structure of the vehicle.

As can be seen from the top plan view in FIG. 1, the fastening elements are all arranged in an identical direction (the X direction). It is provided that the fastening elements are configured such that the aperture body 13 can be mounted on the flap or cover body 3 of the charging or fueling module 1 by a superposed movement of the aperture body 13 in the X/Z direction relative to the flap or cover body 3. On the other hand, the fastening elements are configured so that a removal of the aperture body 13 from the flap or cover body 3 is possible, namely by exerting a critical force component acting in the Y direction on the aperture body 13.

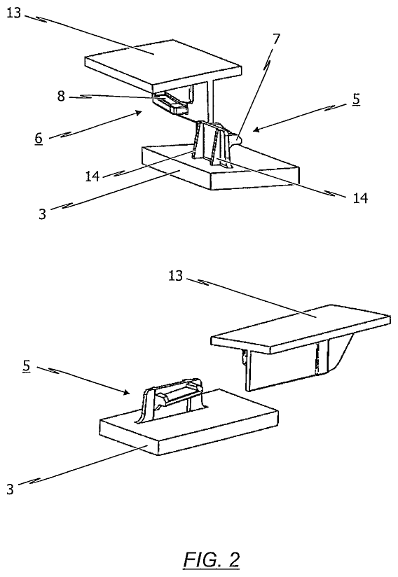

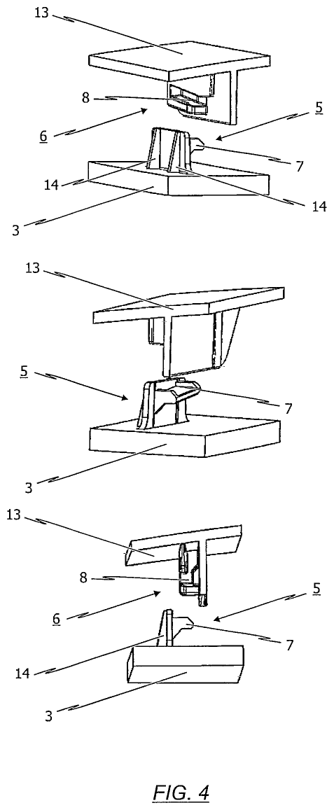

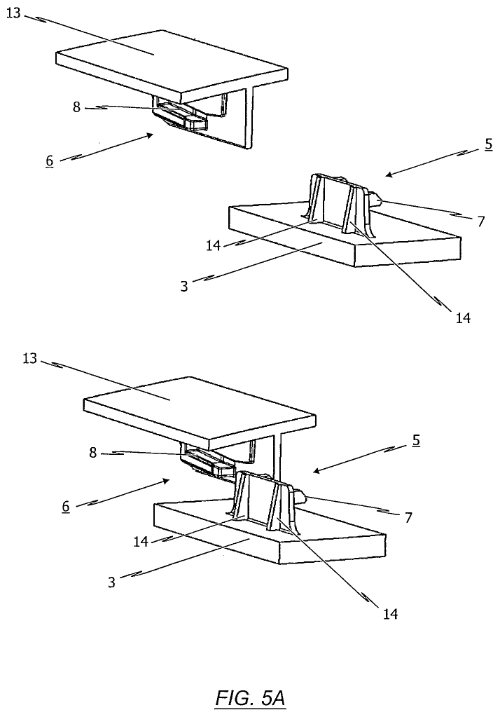

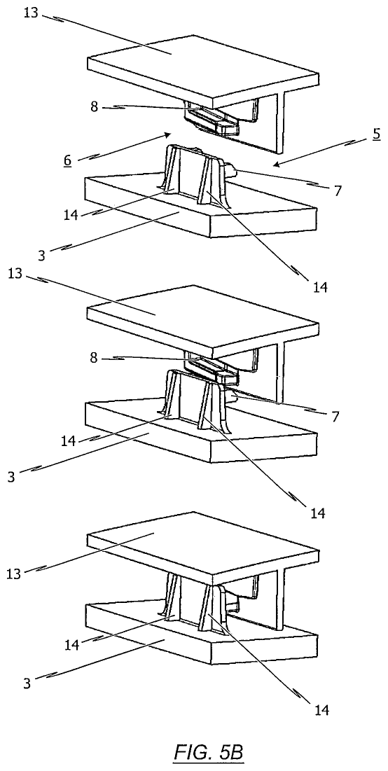

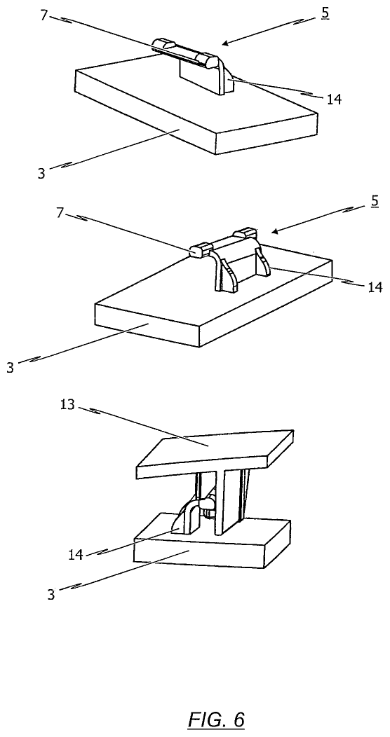

Referring to the illustrations in FIG. 2 to FIG. 6, possible embodiments of the fastening elements are described in greater detail below. Specifically, FIG. 2 schematically illustrates, in isometric views, an exemplary embodiment of the two connection partners of a connection element in the charging or fueling module from FIG. 1, shown in a state where the aperture body is not yet mounted on the flap or cover body. FIG. 3 shows the connection partners of the fastening element from FIG. 2, now in a state where the aperture body (the second connection partner) forms a releasable, positive-locking connection with the flap or cover body (the first connection partner). FIG. 4 demonstrates the connection partners as the aperture body is being removed from the flap or cover body. FIGS. 5A and 5B present additional views of the connection partners from FIG. 2. Lastly, FIG. 6 depicts an alternative embodiment of the connection partners for the charging or fueling module illustrated in FIG. 1.

Each fastening element comprises a first connection partner 5 fixedly connected to the flap or cover body 3 and a second connection partner 6 fixedly connected to a rear side of the aperture body 13. The first connection partner 5 is designed at least partially or regionally in a complementary manner to the second connection partner 6 and is configured to establish a detachable, positive-locking connection with the second connection partner 6.

The connection partners 5, 6 of each fastening element are configured such that the aperture body 13 can also be removed from the flap or cover body 3 when the flap or cover body 3 takes on the closed position. In the fastened or mounted state of the aperture body 13, the connection partners 5, 6 of each fastening element are configured to position the latter in a stressless manner in relation to the flap or cover body 3. Furthermore, the connection partners 5, 6 of each fastening element are configured to lock together in the desired mounting position of the two connection partners 5, 6. For this purpose, the first or second connection partner 5, 6 of each fastening element, and preferably the first connection partner 5, comprises a catching projection 7, which, in the desired mounting position of the two connection partners 5, 6, is configured to engage with and/or catch into a catching receptacle of the other connection partner.

The connection partners 5, 6 of each fastening element are configured such that a positive-locking connection between the connection partners 5, 6 established in a desired mounting position of the connection partners 5, 6 can only be released after overcoming a predefined or definable force, which moves in the Y direction. For this purpose, it is contemplated that the predefined or definable force threshold acting in the Y direction is defined by a tapering reinforcement rib 14, which is associated with one of the two connection partners 5, 6, and with the first connection partner 5, 6.

Specifically, the first and second connection partners 5, 6 of the exemplary embodiment of the fastening element shown in the illustrations, and in particular the second connection partner 6, is at least partially or regionally configured as a socket having a receptacle, wherein a plug element of the other connection partner can be inserted, in particular in the X direction, into the receptacle in order to establish the positive-locking connection with the other connection partner 5.

The receptacles of the connection partners 5, 6 of each fastening element, being configured at least partially or regionally as a socket, are, as can be seen in the top plan view in FIG. 1, arranged parallel to one another, such that, for mounting and/or removing the aperture body 13 on the flap or cover body 3 or from the flap or cover body 3, the aperture body 13 is to be moved in a direction, in particular in a direction parallel to the outer skin of the vehicle, preferably in the X direction, relative to the flap or cover body 3.

It can also be seen in the illustrations in FIG. 2 through FIG. 6 that the receptacle of the connection partner at least partially or regionally configured as a socket is formed by two guide surfaces arranged opposite one another, wherein the guide surfaces are arranged spaced apart from one another such that an interstice for the plug element of the other connection partner is formed.

The receptacle of the connection partner at least partially or regionally configured as a socket is configured such that, when the plug element is inserted, the receptacle is elastically widened, wherein a tensioning and clamping ultimately occurs in the desired mounting position.

In the exemplary embodiments of the fastening elements, it is provided that the connection partners 5, 6 of each fastening element are respectively configured as a plastic part, as an injection-molded plastic part.

The first connection partner 5 of each fastening element can preferably be configured integrally with the flap or cover body 3. On the other hand, the second connection partner 6 of each fastening element can preferably be configured integrally with the aperture body 13, and with the rear side of the aperture body 13.

Although the present disclosure is described in conjunction with the examples of embodiments outlined above, various alternatives, modifications, variations, improvements, and/or substantial equivalents that are known or current or to be anticipated before long may be obvious to those of at least ordinary skill in the art. In addition, the technical effects and/or technical problems described in the present disclosure are illustrative rather than restrictive. Therefore, the disclosed description in the present disclosure may be used to solve other technical problems and have other technical effects and/or may solve other technical problems. Accordingly, the examples of the embodiments of the present disclosure as set forth above are intended to be illustrative rather than limiting. Various changes can be made without departing from the spirit or scope of the present disclosure. Therefore, the present disclosure is intended to include all known or earlier developed alternatives, modifications, variations, improvements and/or basic equivalents.

### LIST OF REFERENCE NUMERALS

1 Charging or fueling module
2 Base body
3 Flap or cover body
5 First connection partner of a fastening element
6 Second connection partner of a fastening element
7 Catching projection of the first connection partner
8 Catching receptacle of the second connection partner
13 Aperture body
14 Reinforcement rib

What is claimed is:

1. A charging or fueling module (1) of a vehicle, wherein the charging or fueling module (1) comprises the following:
a base body (2) for mounting the charging or fueling module (1) on a body structure of the vehicle;
a flap or cover body (3) mounted pivotally or movably on the base body (2); and
an aperture body (13) mounted on the flap or cover body (3) or on a retaining body of the flap or cover body (3) via a plurality of fastening elements, which, when the flap or cover body (3) takes on a closed position, extends flush with an outer skin of the body structure of the vehicle,
wherein each fastening element comprises a first connection partner (5) fixedly connected to the flap or cover body (3) or to the retaining body of the flap or cover body (3) and a second connection partner (6) fixedly connected to a rear side of the aperture body (13), wherein the first connection partner (5) is arranged at least partially or regionally in a complementary manner to the second connection partner (6) and is configured to form a releasable, positive-locking connection with the second connection partner (6).

2. The charging or fueling module (1) according to claim 1,
wherein the connection partners (5, 6) of each fastening element are configured such that the aperture body (13) can also be removed from the flap or cover body (3) or from the retaining body of the flap or cover body (3) when the flap or cover body (3) takes on the closed position.

3. The charging or fueling module (1) according to claim 1,
wherein, in the fastened or mounted state of the aperture body (13), the connection partners (5, 6) of each fastening element are configured to position the latter in a stressless manner in relation to the flap or cover body (3) or in relation to the retaining body of the flap or cover body (3).

4. The charging or fueling module (1) according to claim 1,
wherein the first or second connection partner(s) (5, 6) of each fastening element is/are configured to lock together in a desired mounting position of the two connection partners (5, 6).

5. The charging or fueling module (1) according to claim 4,
wherein the first or second connection partner (5, 6) of each fastening element, and the first connection partner (5), comprises at least one catching projection (7), which, in the desired mounting position of the two connection partners (5, 6), is configured to engage with or catch into a catching receptacle of the other connection partner.

6. The charging or fueling module (1) according to claim 4,
wherein the connection partners (5, 6) of each fastening element are configured such that a positive-locking connection between the connection partners (5, 6) established in the desired mounting position of the connection partners (5, 6) can only be released after overcoming a predefined or definable force threshold, which acts in a Y direction.

7. The charging or fueling module (1) according to claim 6,
wherein the predefined or definable force threshold acting in the Y direction is defined by at least one tapering reinforcement rib (14), which is associated with one of the two connection partners (5, 6), and with the first connection partner (5).

8. The charging or fueling module (1) according to claim 1,
wherein the fastening elements are configured such that the aperture body (13) can be mounted on the flap or cover body (3) or on the retaining body of the flap or cover body (3) by a movement, in particular by a superposed movement, of the aperture body (13) relative to the flap or cover body (3) or relative to the retaining body of the flap or cover body (3).

9. The charging or fueling module (1) according to claim 1,
wherein the fastening elements are configured such that the aperture body (13) can be removed from the flap or cover body (3) or from the retaining body of the flap or cover body (3) by introduction of a predefined or definable critical force component in a Y direction, by introduction of a predefined or definable critical force component purely in the Y direction from the flap or cover body (3) or from the retaining body of the flap or cover body (3).

10. The charging or fueling module (1) according to claim 1,
wherein the first or second connection partner (5, 6) of each fastening element, and the second connection partner (6), is at least partially or regionally configured as a socket having a receptacle, wherein a plug element of the other connection partner can be inserted, in the X direction, into the receptacle to establish the positive-locking connection with the other connection partner (5).

11. The charging or fueling module (1) according to claim 10,
wherein the receptacles of the connection partners (5, 6) of each fastening element, being configured at least partially or regionally as a socket, are arranged parallel to one another, such that, for mounting or removing the aperture body (13) on the flap or cover body (3), or from the flap or cover body (3), or on the retaining body of the flap or cover body (3), or from the retaining body of the flap or cover body (3), the aperture body (13) is to be moved in a direction, in particular in a direction parallel to the outer skin of the vehicle, relative to the flap or cover body (3) or to the retaining body of the flap or cover body (3).

12. The charging or fueling module (1) according to claim 10,
wherein the receptacle of the connection partner (5, 6) at least partially or regionally configured as a socket is formed by two guide surfaces arranged opposite one another, wherein the guide surfaces are arranged spaced apart from one another such that an interstice for the plug element is formed.

13. The charging or fueling module (1) according to claim 10,
wherein the receptacle of the connection partner (5, 6) at least partially or regionally configured as a socket is configured such that, when the plug element is inserted, the receptacle is elastically widened, wherein a tensioning and clamping ultimately occurs in a desired mounting position.

14. The charging or fueling module (1) according to claim 1,
wherein the connection partners (5, 6) of each fastening element are each configured as a plastic part, in particular as an injection-molded plastic part, wherein the first connection partner (5) of each fastening element is configured integrally with the flap or cover body (3) or the retaining body of the flap or cover body (3), and wherein the second connection partner (6) of each fastening element is configured integrally with the aperture body (13), and in particular with the rear side of the aperture body (13).
